(19) United States
(12) Patent Application Publication
(10) Pub. No.: US 2026/0093072 A1
(43) Pub. Date: Apr. 2, 2026

(54) FIBER OPTIC ADAPTER

(71) Applicant: HYC Co., Ltd, Guangdong (CN)

(72) Inventors: Lei ZHU, Guangdong (CN); Haibo YANG, Guangdong (CN); Chengyu HUANG, Guangdong (CN); Huangliang WU, Guangdong (CN)

(21) Appl. No.: 18/967,553

(22) Filed: Dec. 3, 2024

(30) Foreign Application Priority Data
Sep. 27, 2024 (CN) 202422369382.7

(51) Int. Cl. G02B 6/38

(52) U.S. Cl. CPC G02B 6/3825; G02B 6/3849

(57) ABSTRACT

A fiber optic adapter includes a main body shell and a shielding door assembly. The main body shell has an installation passage. The shielding door assembly includes a door body and an elastic member. The door body is located in the installation passage to block the installation passage; the door body is hinged to the main body shell, and the elastic member connects the door body and the main body shell. Protective protrusions are provided on one side of the door body abutted against by the fiber optic connector, and when the fiber optic connector abuts against the protective protrusions, the protective protrusions are misaligned with a fiber core of the fiber optic connector, the door body is not in contact with the fiber core of the fiber optic connector, and there is a gap between the door body and the fiber core of the fiber optic connector.

### CROSS-REFERENCE TO RELATED APPLICATION(S)

This application claims priority to Chinese Patent Application No. 202422369382.7 filed Sep. 27, 2024, the disclosure of which is incorporated herein by reference in its entirety.

### TECHNICAL FIELD

This disclosure relates to the field of fiber-optic communication technology, and in particular to a fiber optic adapter.

### BACKGROUND

A fiber optic adapter is used to connect two fiber optic connectors, where one fiber optic connector is generally fixed at one end of the fiber optic adapter. When the optical fiber needs to be connected, the other fiber optic connector is plugged into the other end of the fiber optic adapter for connection.

The fiber optic connector fixed on the fiber optic adapter can emit communication light, and the communication light has high energy and cannot be recognized by the human eye, therefore, when the other fiber optic connector is not plugged into the fiber optic adapter, the emitted communication light can damage the human eye. Further, when the other fiber optic connector is not plugged in, dust and other litters are prone to be accumulated in the fiber optic adapter, and dust and other litters will interfere with the connection of the two fiber optic connectors, thereby causing potential risks in use;

In order to solve the above problems, a shielding door is generally used in the related art. When the shielding door is used, the fiber optic connector is used to push the shielding door. Since pushing with the fiber optic connector is adopted, it is prone to damage the fiber core of the fiber optic connector, which is prone to cause instability after connection.

### SUMMARY

A purpose of the present disclosure is to provide a fiber optic adapter to solve the problem of being prone to cause damage to the fiber core of the fiber optic connector.

To achieve this purpose, the following technical solutions are adopted in the present disclosure.

A fiber optic adapter, includes: a main body shell and a shielding door assembly.

The main body shell has an installation passage.

The shielding door assembly includes a door body and an elastic member. The door body is located in the installation passage to block the installation passage; and the door body is hinged to the main body shell, and the elastic member connects the door body and the main body shell.

When the fiber optic connector abuts against the door body, the door body is squeezed to rotate and open the installation passage, to allow the elastic member to accumulate potential energy to drive the door body to maintain the tendency of blocking the installation passage.

A side of the door body abutted against by the fiber optic connector is provided with protective protrusions, and when the fiber optic connector abuts against the protective protrusions, the protective protrusions are misaligned with a fiber core of the fiber optic connector.

In some embodiments, two protective protrusions are provided, and each of the two protective protrusions is located on a respective side of two sides of a center of the door body.

In some embodiments, each of the protective protrusions is strip-shaped, and each of the protective protrusions extends from one end of the door body hinged to the main body shell to the other end of the door body.

In some embodiments, a limiting protrusion is provided inside the main body shell, and the door body is arranged to block the installation passage when the door body abuts against the limiting protrusion.

In some embodiments, the main body shell includes an inner shell and an outer shell, the outer shell is sleeved on the inner shell, and the inner shell is snap-fitted with the outer shell.

In some embodiments, the outer shell is provided with a snap-fitting hole, the inner shell is provided with an elastic snap-fit block, and the elastic snap-fit block is arranged to be snap-fitted in the snap-fitting hole.

In some embodiments, a limiting protrusion is further provided on an outer side of the inner shell, an inner wall of the outer shell is provided with a retaining groove in a depth direction of the installation passage, and the limiting protrusion is embedded in and matched with the retaining groove and matched with the retaining groove.

In some embodiments, an embedding recess is provided in the inner shell, the door body is hinged in the embedding recess through a rotating shaft, and when the door body is placed in the embedding recess, an end surface of each of the protective protrusions is flush with an end surface of an opening of the embedding recess.

In some embodiments, the elastic member is a torque spring, the torque spring is sleeved on the rotating shaft, and each of the door body and a bottom of the embedding recess is provided with an accommodating groove for accommodating the torque spring.

In some embodiments, the inner shell includes a first shell part and a second shell part, and the first shell part and the second shell part are detachably connected.

Beneficial effects of the disclosure is as follows.

The side of the door body abutted against by the fiber optic connector is provided with the protective protrusions, and when the fiber optic connector abuts against the door body, the protective protrusions are misaligned with the fiber core of the fiber optic connector, so that when the protective protrusions are in contact with the fiber optic connector, the fiber core of the fiber optic connector is not in contact with the door body, and there is a gap between the fiber core of the fiber optic connector and the door body. In this manner, the fiber core of the fiber optic connector may not be adversely affected, thereby avoiding damage to the fiber core and avoiding instability after the fiber optic connector is connected.

### BRIEF DESCRIPTION OF DRAWINGS

FIG. 1 is a schematic diagram of a fiber optic adapter according to the present disclosure;

FIG. 2 is a cross-sectional view of a main body shell of the fiber optic adapter according to the present disclosure;

FIG. 3 is a schematic diagram of an outer shell of the fiber optic adapter according to the present disclosure;

FIG. 4 is a schematic diagram showing an inner shell and a shielding door assembly of the fiber optic adapter according to the present disclosure from one perspective;

FIG. 5 is a schematic diagram showing the inner shell and the shielding door assembly of the fiber optic adapter according to the present disclosure from another perspective;

FIG. 6 is a schematic structural diagram of a door body of the fiber optic adapter according to the present disclosure; and

FIG. 7 is a partial cross-sectional view showing a slot of the fiber optic adapter according to the present disclosure.

### REFERENCES LIST

1. Main body shell
11. Inner shell
111. First shell part
112. Second shell part
113. Notch
12. Outer shell
13. Snap-fitting hole
14. Elastic snap-fit block
141. Connecting plate
142. Snap-fitting protrusion
15. Limiting protrusion
16. Retaining groove
17. Embedding recess
2. Shielding door assembly
21. Door body
22. Elastic member
23. Protective protrusion
24. Clamping protrusion
25. Slot
3. Limiting protrusion

### DETAILED DESCRIPTION

The present disclosure is further described in detail hereinafter in conjunction with the drawings and embodiments. It can be understood that the embodiments described here are only intended to explain the present disclosure, rather than limiting the present disclosure. It should also be noted that, for the convenience of description, only part of structures related to the present disclosure rather than all the structures are shown in the drawings.

In the description of the present disclosure, it is to be noted that, unless otherwise expressly specified and limited, the terms “connected to each other”, “connected” or “fixed” are to be construed in a broad sense, for example, as permanently connected or detachably connected or integrally formed; mechanically connected or electrically connected; directly connected to each other or indirectly connected to each other via an intermediary; or internally connection of two components or interaction relationship between two components. For persons of ordinary skill in the art, specific meanings of the preceding terms in the present disclosure may be construed based on specific situations.

In the present disclosure, unless otherwise expressly specified and limited, when a first feature is described as “above” or “below” a second feature, the first feature and the second feature may be in direct contact, or be in contact via another feature between the two features. Moreover, when the first feature is described as “on”, “above” or “over” the second feature, the first feature is right on, above or over the second feature or the first feature is diagonally on, above or over the second feature; or the first feature is simply at a higher level than the second feature. When the first feature is described as “under”, “below” or “underneath” the second feature, the first feature is right under, below or underneath the second feature or the first feature is diagonally under, below or underneath the second feature, or the first feature is simply at a lower level than the second feature.

In the description of this article, it should be understood that the orientation or position relationships indicated by the terms such as “upper”, “lower”, “left”, “right”, etc., are based on the orientation or position relationship shown in the drawings, which is only for the convenience of description and simplification of operation, and does not indicate or imply that the device or element referred to must have a specific orientation, be constructed and operated in a specific orientation, and therefore cannot be understood as a limitation of the present disclosure. Furthermore, the terms “first” and “second” are only used to distinguish in the description and have no special meaning.

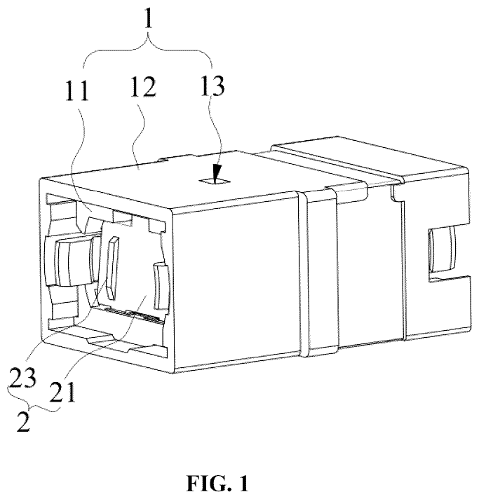

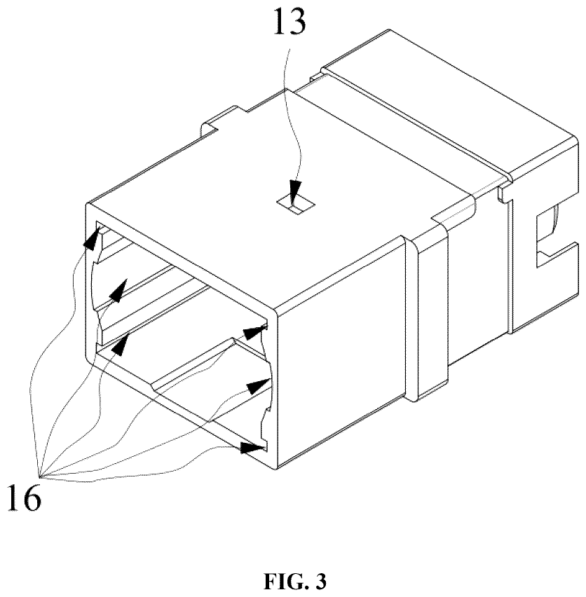

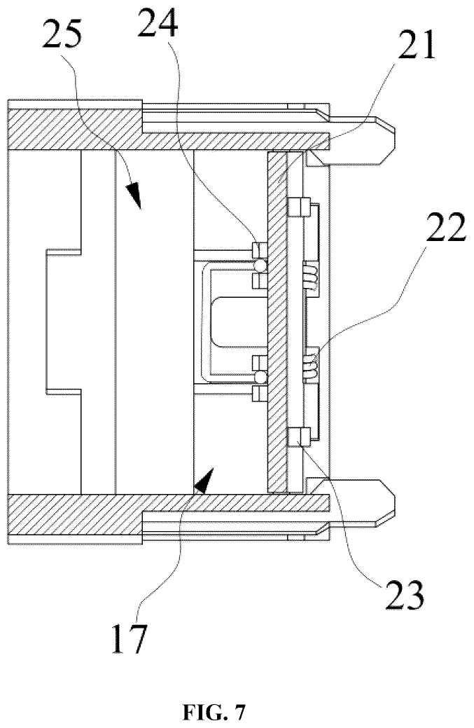

As shown in FIG. 1 to FIG. 7, a fiber optic adapter is provided according to the disclosure, which includes a main body shell 1 and a shielding door assembly 2. The main body shell 1 has an installation passage. The shielding door assembly 2 includes a door body 21 and an elastic member 22. The door body 21 is located in the installation passage to block the installation passage. The door body 21 is hinged to the main body shell 1, and the elastic member 22 connects the door body 21 and the main body shell 1. When the fiber optic connector abuts against the door body 21, the door body 21 is squeezed to rotate and open the installation passage, so that the elastic member 22 can accumulate potential energy to drive the door body 21 to maintain the tendency of blocking the installation passage. A side of the door body 21 abutted against by the fiber optic connector is provided with protective protrusions 23. When the fiber optic connector abuts against the protective protrusions 23, the protective protrusions 23 are misaligned with a fiber core of the fiber optic connector.

The protective protrusions 23 are provided on the side of the door body 21 abutted against by the fiber optic connector, and when the fiber optic connector abuts against the door body 21, the protective protrusions 23 are misaligned with the fiber core of the fiber optic connector, so that the protective protrusions 23 are in contact with the fiber optic connector, while the door body 21 is not in contact with the fiber core of the fiber optic connector, and there is a gap between the door body 21 and the fiber core of the fiber optic connector. In this manner, the fiber core of the fiber optic connector may not be adversely affected, thereby avoiding damage to the fiber core and thus avoiding instability after the fiber optic connector is connected.

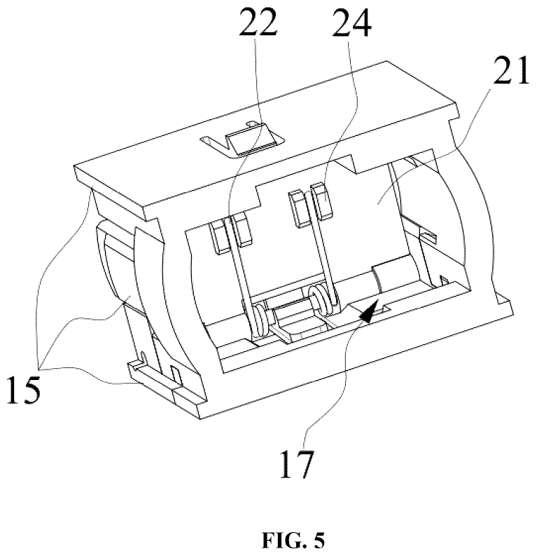

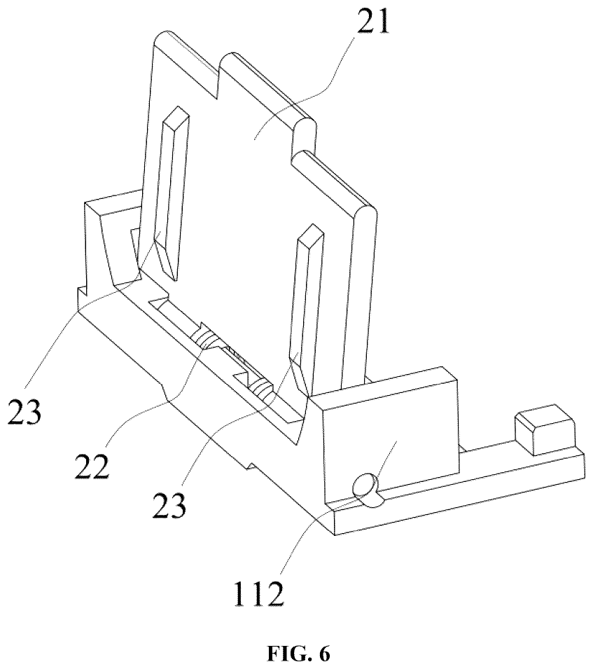

Generally, the fiber core of the fiber optic connector is located at the center of the fiber optic connector, as shown in FIG. 5 and FIG. 6. In some embodiments, two protective protrusions 23 are provided, and each of the two protective protrusions 23 are located on a respective side of two sides of the center of the door body 21. With this arrangement, in one aspect, the above-mentioned fiber core can be prevented from being abutted against; and in another aspect, when the fiber optic connector abuts against the protective protrusions 23, the force on the door body 21 is uniform, ensuring the stability of the rotation, and avoiding the door body 21 from tilting to be in contact with the fiber core.

In some embodiments, after the fiber optic connector abuts against the above protective protrusions 23, it is necessary to continue to push the fiber optic connector to move deep into the installation passage for connection. And in order to avoid the interference of the protective protrusions 23 on the moving operation of the fiber optic connector, each of the protective protrusions 23 is strip-shaped, extending from one end of the door body 21 at which the door body 21 is hinged to the main body shell 1 to the other end of the door body 21. That is, when the door body 21 is knocked down by the fiber optic connector, the extension direction of the protective protrusions 23 in this case is the same as the moving direction of the fiber optic connector, thereby avoiding the phenomenon that the fiber optic connector is blocked by the protective protrusions 23. Furthermore, sides of two ends of each of the protective protrusions 23 away from the door body 21 are chamfered, so that whether to plug or unplug the fiber optic connector, it can avoid interference of the fiber optic connector with the two ends of each of the protective protrusions 23 away from the door body 21.

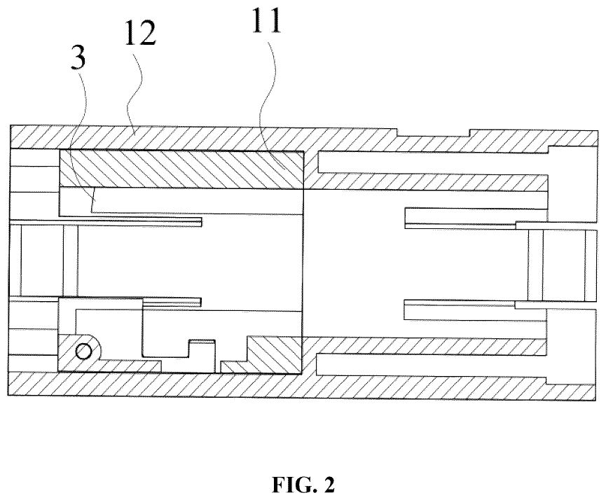

As shown in FIG. 2, an inner wall of the main body shell 1 is further provided with a limiting protrusion 3. When the door body 21 abuts against the limiting protrusion 3, the door body 21 blocks the installation passage. Based on this, when the elastic member 22 drives the door body 21 back to block the installation passage, the limiting protrusion 3 abuts against the door body 21, which can prevent the door body 21 from being abutted against and rotated excessively by the potential energy of the elastic member 22.

As shown in FIG. 1 to FIG. 4, in order to facilitate the installation of the overall fiber optic adapter, in some embodiments, the main body shell 1 includes an inner shell 11 and an outer shell 12, and the outer shell 12 is sleeved on an outer side of the inner shell 11. Where one the fiber optic connector is fixedly plugged into one end of the outer shell 12; and when in use, it is simply required to plug the other fiber optic connector into the other end of the outer shell 12. In one or more embodiments, the outer shell 12 is snap-fitted with the inner shell 11, thereby facilitating the assembly of the main body shell 1. In one or more embodiments, the outer shell 12 is provided with a snap-fitting hole 13, the inner shell 11 is provided with an elastic snap-fit block 14, and the elastic snap-fit block 14 can be snap-fitted into the snap-fitting hole 13 to fix the inner shell 11 to the outer shell 12. In the current embodiment, the inner shell 11 is provided with a notch 113, and the elastic snap-fit block 14 includes a connecting plate 141 and a snap-fitting protrusion 142. The connecting plate 141 has one end connected to an inner wall of the notch 113 and extends in a depth direction of the installation passage. The snap-fitting protrusion 142 is provided at the other end of the connecting plate 141, so that the inner shell 11 can be pushed from one end of the outer shell 12 into the outer shell 12 for installation. When the snap-fitting protrusion 142 abuts against an inner wall of the outer shell 12, the connecting plate 141 is slightly deformed, and the inner shell 11 is continued to be pushed till the snap-fitting protrusion 142 is embedded in the snap-fitting hole 13. In some other embodiments, the elastic snap-fit block 14 may adapt other elastic positioning means such as a ball-type positioning pin.

In order to prevent the inner shell 11 from shaking after installation and maintain the stability of the inner shell 11, a limiting protrusion 15 is further provided on an outer side of the inner shell 11, and the inner wall of the outer shell 12 is provided with a retaining groove 16 in the depth direction of the installation passage. The limiting protrusion 15 is embedded in the retaining groove 16 and matched with the retaining groove 16. To facilitate alignment and installation, one end of the retaining groove 16 extends through a port of the outer shell 12. Thus, when installing, it is simply required to align the limiting protrusion 15 with the above-mentioned retaining groove 16 and push the inner shell 11 to complete the installation. Multiple limiting protrusions 15 can be provided, and they can be evenly distributed on the outer side of the inner shell 11.

As shown in FIG. 5 to FIG. 7, in some embodiments, an embedding recess 17 is provided in the inner shell 11, and the door body 21 is hinged in the embedding recess 17 through a rotating shaft, so that when the fiber optic connector pushes open the door body 21 to enter the installation passage, the door body 21 is placed in the embedding recess 17, and an end surface of each of the protective protrusions 23 is flush with an end surface of the opening of the embedding recess 17. That is, the door body 21 is received in the embedding recess 17, so that the fiber optic connector can continue to move forward, reducing unnecessary interference. In one or more embodiments, the embedding recess 17 is provided with opposing installation holes, a rotating shaft is inserted into the installation holes, and the door body 21 is rotatably connected to the rotating shaft. The elastic member 22 uses a torque spring, which is sleeved on the rotating shaft, and each of the door body 21 and the bottom of the embedding recess 17 is provided with an accommodating groove for accommodating the torque spring, so that the door body 21 is enabled to smoothly press the torque spring when rotating, to allow the torque spring to accumulate elastic potential energy. In the current embodiment, the accommodating groove at the bottom of the embedding recess 17 is formed by a depression in a bottom wall of the recess; and the accommodating groove in the door body 21 is formed by clamping protrusions 24 arranged at intervals on the door body 21, thereby avoiding grooving in the door body 21 and adversely affecting the strength of the door body 21. Based on the existence of the above clamping protrusions 24, a slot 25 is provided at the bottom of the accommodating groove, so that the clamping protrusions 24 can be embedded in the slot 25 to avoid protruding out of the accommodating groove. It is to be noted here that the limiting protrusion 3 is located on an inner wall of the inner shell 11.

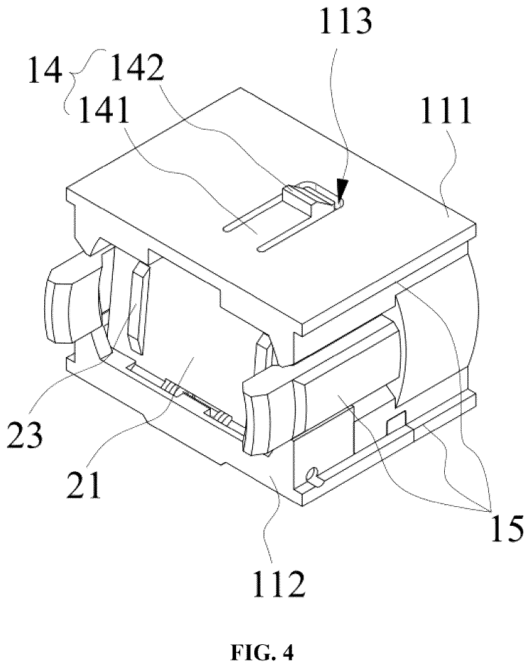

As shown in FIG. 4, in some embodiments, in order to facilitate the installation of the door body 21 and the elastic member 22, the inner shell 11 is divided into a first shell part 111 and a second shell part 112, and the first shell part 111 and the second shell part 112 are detachably connected, so that after the door body 21 and the elastic member 22 are installed, the first shell part 111 and the second shell part 112 are connected together to form a complete inner shell 11. It should be noted here that the boundary between the first shell part 111 and the second shell part 112 is not specifically limited. In the current embodiment, one of the first shell part 111 and the second shell part 112 is provided with a snap-in block, and the other one of the first shell part 111 and the second shell part 112 is provided with a snap-in groove, so that the first shell part 111 and the second shell part 112 are snap-fitted to each other to form a complete inner shell 11, and the outer shell 12 is sleeved on the outer sides of the first shell part 111 and the second shell part 112, so as to stably connect the first shell part 111 and the second shell part 112 together.

Obviously, the above embodiments of the present disclosure are merely examples for clearly illustrating the present disclosure, and are not intended to limit the implementation methods of the present disclosure. For persons of ordinary skill in the art, various obvious changes, readjustments and substitutions can be made without departing from the scope of protection of the present disclosure. It is not necessary and impossible to list all the implementation methods here. Any modification, equivalent substitution and improvement made within the spirit and principle of the present disclosure should be included in the scope of protection of the claims of the present disclosure.

What is claimed is:

1. A fiber optic adapter, comprising:
a main body shell having an installation passage; and
a shielding door assembly, comprising a door body and an elastic member, wherein the door body is located in the installation passage to block the installation passage, the door body is hinged to the main body shell, and the elastic member connects the door body and the main body shell;
wherein when a fiber optic connector abuts against the door body, the door body is squeezed to rotate and open the installation passage, to allow the elastic member to accumulate potential energy to drive the door body to maintain the tendency of blocking the installation passage; and
wherein a side of the door body abutted against by the fiber optic connector is provided with protective protrusions, and when the fiber optic connector abuts against the protective protrusions, the protective protrusions are misaligned with a fiber core of the fiber optic connector.

2. The fiber optic adapter according to claim 1, wherein two protective protrusions are provided, and each of the two protective protrusions is located on a respective side of two sides of a center of the door body.

3. The fiber optic adapter according to claim 2, wherein each of the protective protrusions is strip-shaped, and each of the protective protrusions extends from one end of the door body hinged to the main body shell to the other end of the door body.

4. The fiber optic adapter according to claim 1, wherein a limiting protrusion is provided inside the main body shell, and the door body is arranged to block the installation passage when the door body abuts against the limiting protrusion.

5. The fiber optic adapter according to claim 1, wherein the main body shell comprises an inner shell and an outer shell, the outer shell is sleeved on the inner shell, and the inner shell is snap-fitted with the outer shell.

6. The fiber optic adapter according to claim 5, wherein the outer shell is provided with a snap-fitting hole, the inner shell is provided with an elastic snap-fit block, and the elastic snap-fit block is arranged to be snap-fitted in the snap-fitting hole.

7. The fiber optic adapter according to claim 6, wherein a limiting protrusion is further provided on an outer side of the inner shell, an inner wall of the outer shell is provided with a retaining groove in a depth direction of the installation passage, and the limiting protrusion is embedded in and matched with the retaining groove.

8. The fiber optic adapter according to claim 5, wherein an embedding recess is provided in the inner shell, the door body is hinged in the embedding recess through a rotating shaft, and when the door body is placed in the embedding recess, an end surface of each of the protective protrusions is flush with an end surface of an opening of the embedding recess.

9. The fiber optic adapter according to claim 8, wherein the elastic member is a torque spring, the torque spring is sleeved on the rotating shaft, and each of the door body and a bottom of the embedding recess is provided with an accommodating groove for accommodating the torque spring.

10. The fiber optic adapter according to claim 5, wherein the inner shell comprises a first shell part and a second shell part, and the first shell part and the second shell part are detachably connected.
